(19) United States
(12) Patent Application Publication
(10) Pub. No.: US 2019/0274197 A1
(43) Pub. Date: Sep. 5, 2019

(54) RIDE THROUGH MODE IN LED BACKLIGHT DRIVER FOR AUTOMOTIVE IDLE STOP AND COLD CRANK OPERATION

(71) Applicant: Semtech Corporation, Camarillo, CA (US)

(72) Inventors: Chin Chang, Agoura Hills, CA (US); Woody Chen, New Taipei City (TW)

(73) Assignee: Semtech Corporation, Camarillo, CA (US)

(21) Appl. No.: 16/292,876

(22) Filed: Mar. 5, 2019

Related U.S. Application Data
(60) Provisional application No. 62/638,401, filed on Mar. 5, 2018.

(51) Int. Cl. H05B 33/08; H02M 3/156

(52) U.S. Cl. CPC H05B 33/0815; H02M 3/156

(57) ABSTRACT

A circuit comprising a first regulator coupled to a voltage input, a second regulator coupled to a voltage output and a switch coupled to the first regulator and the second regulator, wherein the switch is configured to provide voltage to a load from the voltage input when the voltage input is greater than a first predetermined voltage, and to provide voltage to the load from the voltage output when the voltage input is lower than a second predetermined voltage.

### RELATED APPLICATIONS

This application claims benefit of and priority to U.S. provisional patent application 62/638,401, filed Mar. 5, 2018, which is hereby incorporated by reference for all purposes as if set forth herein in its entirety.

### TECHNICAL FIELD

The present disclosure relates generally to vehicular lighting, and more specifically to a system and method for removing unwanted display flickling under frequent start-stop operation in next generation energy efficient vehicles.

### BACKGROUND OF THE INVENTION

In LED driver products, a brute force approach is used to meet the “ride-through” requirement, which is the requirement for supply voltage range variability. Circuits are typically designed to be driven by a wide input voltage range, to encompass lower voltage conditions during start/stop operation of the vehicle, and voltage conditions under normal operation. That approach is inefficient.

### SUMMARY OF THE INVENTION

A circuit is disclosed that includes a first regulator coupled to a voltage input and a second regulator coupled to a voltage output. A switch is coupled to the first regulator and the second regulator that is configured to provide voltage to a load from the voltage input when the voltage input is greater than a first predetermined voltage, and to provide voltage to the load from the voltage output when the voltage input is lower than a second predetermined voltage.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a pin-out diagram of an application circuit having a ride-through function, in accordance with an example embodiment of the present disclosure;

FIG. 2 is a diagram showing voltage waveforms, in accordance with an example embodiment of the present disclosure;

FIG. 3 is a diagram of a ride-through circuit, in accordance with an example embodiment of the present disclosure;

FIG. 4 is a diagram of a second embodiment of a ride-through circuit, in accordance with an example embodiment of the present disclosure; and

FIG. 5 is a diagram of the V_{IN}, V_{OUT}, V_{DD} and LED current (I_{OUT}) waveforms of a circuit controlled by an example device in accordance with the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The disadvantages of the old method of “ride-through” design, where a brute force approach is used by designing circuits to be driven by a wide input voltage range, to encompass lower voltage conditions during start/stop operation of a vehicle, and voltage conditions under normal operation, include lower circuit efficiency and increased solution cost. In order to accommodate the wide input voltage range, the circuit or integrated device needs to be designed and manufactured under high voltage process, in order to help cover the high end of the voltage range. Correspondingly, the on resistance of the devices will be increased with silicon size limitation. Such increased on resistance will lead to lower circuit efficiency, especially at lower input voltage operating conditions. To help make the device or integrated circuit thermally manageable in applications, the silicon size may be increased slightly to help reduce the on resistance. At the end, the design results in a solution that has lower efficiency and higher cost than a solution with a narrower input voltage range in steady state.

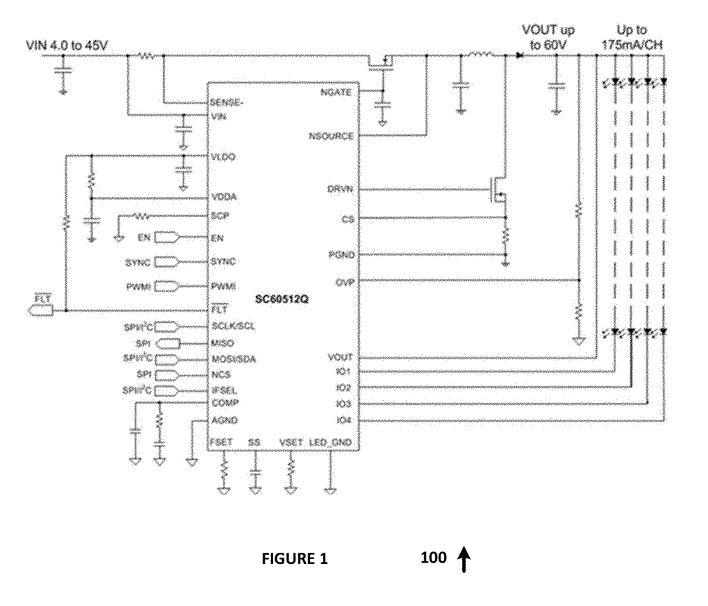

FIG. 1 is a pin-out diagram 100 of an application circuit having a ride-through function, in accordance with an example embodiment of the present disclosure. Pin-out diagram 100 provides a novel and non-obvious technique and corresponding circuitry for allowing an LED driver to ride through an input voltage dip during an automobile start/stop operation, while achieving high efficiency with lower cost.

The normal input operating voltage range V_{IN} of pin-out diagram 100 can range from 4.0V to 45V in one example embodiment, but is not limited to this range and can be higher or lower as may be dictated by a specific design implementation. V_{OUT} can range up to 60V in this example embodiment, with up to 175 mA of current provided per channel for LED drivers, and control provided by IO outputs IO1 through IO4. The application circuit can also include other suitable inputs and outputs, such as a very low dropout linear regulator (VLDO) input, a short circuit protection (SCP) input, an enable (EN) input, a synchronization signal (SYNC) input, a pulse wave modulation input (PWMI), a fault latch timer (FLT) output and so forth.

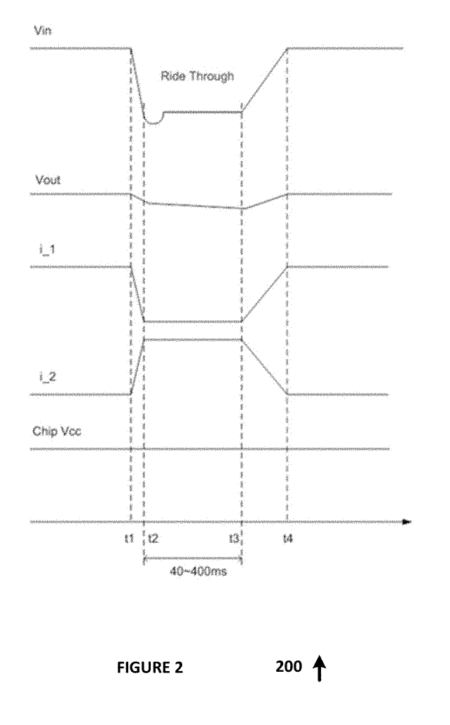

FIG. 2 is a diagram 200 showing voltage waveforms, in accordance with an example embodiment of the present disclosure. Diagram 200 includes input voltage V_{IN}, output voltage V_{OUT}, currents I_1 and I_2, chip Vcc and timing indications t1 through t4.

During the start/stop operation of a vehicle, the input voltage can momentarily dip down to 4V or lower for a short period of time, starting at t2 and ending at t3 (for example 40 ms-400 ms as shown in diagram 200). In order to help a circuit that is receiving the input voltage to ride through such short time period input voltage variations without shutting down the controller, causing LED blinking or causing other undesirable and potentially damaging effects, the voltage supply V_{CC} to the controller (such as V_{DDA} in pin-out diagram 100) can be maintained above its threshold during this V_{IN} voltage dipping duration by an adjunct circuit, as shown and discussed further herein. In particular, the current I_1 during this drop in V_{IN} is compensated for by the adjunct circuit providing a current I_2, which is generated from the voltage output V_{OUT} and to prevent misoperation.

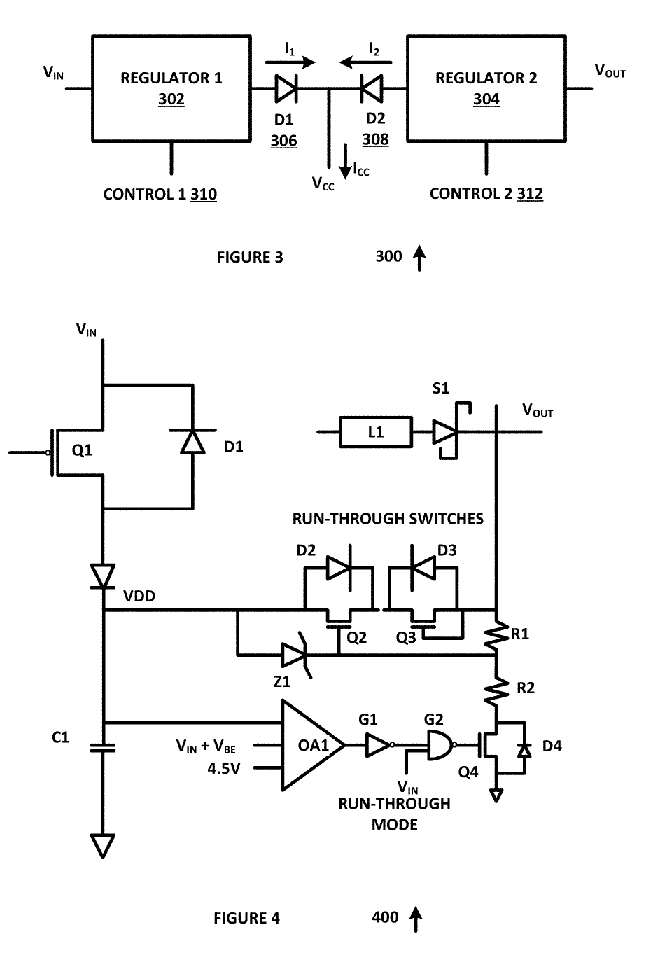

FIG. 3 is a diagram of a ride-through circuit 300, in accordance with an example embodiment of the present disclosure. Ride-through circuit 300 includes regulator 1 302, regulator 2 304, diode 306, diode 308, control 1 310 and control 2 312, and can be implemented in hardware or a suitable combination of hardware and software, such as where regulator 1 302 and regulator 2 304 have programmable control functionality.

Power can be supplied to a circuit from V_{CC}, which is powered by regulator 1 302 and regulator 2 304. The outputs of regulator 1 302 and regulator 2 304 are selected using diodes 306 and 308, which are connected in a logical OR configuration, and can supply the circuit with I_{CC}, which equals I₁ plus I₂. For a circuit such as a boost converter-based LED backlight driver, such as SC60512Q shown in FIG. 1 or other suitable circuits, the voltage at V_{OUT} is significantly higher than the voltage at V_{IN}. As such, when the input voltage V_{IN} dips down below a predetermined voltage, such as 4V, the current I₁ from regulator 1 302 will drop significantly and can even reach zero, as illustrated in FIG. 2.

In this case, regulator 2 304 can turn on, either automatically or in response to control 2 312, such that V_{OUT} will supply I_{CC} with I₂ via regulator 2 304 and diode 308, as shown in FIG. 3. Likewise, regulator 1 302 can turn off, either automatically or in response to control 1 310. During this process, V_{OUT} may drop slightly, but can remain high enough to supply I_{CC} for a predetermined period of time. By the time that the V_{IN} dip passes and recovers, such as by the time t4 shown in FIG. 2, V_{IN} can supply I_{CC} via regulator 1 302, and regulator 2 304 can be turned off automatically or by control 2 312, or in other suitable manners. The associated circuit and LED driver (or other suitable circuit) can continue normal operation during this period. As a consequence, the LED light remains almost constant without disturbance during this V_{IN} dip event, such as may occur during start/stop operation or at other times, or other suitable applications will not experience severe voltage transients.

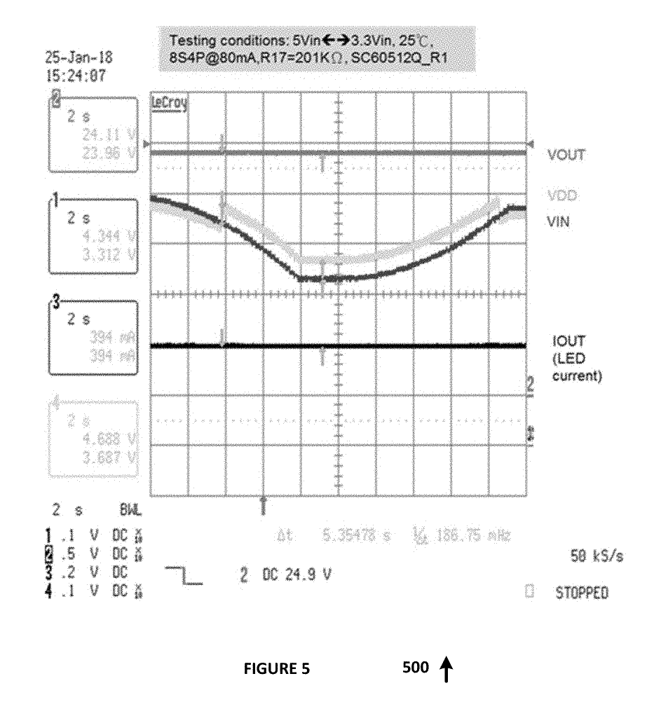

FIG. 4 is a diagram 400 of a second embodiment of a ride-through circuit, in accordance with an example embodiment of the present disclosure. Diagram 400 includes diodes D1 through D4, zener diode Z1, Schottky diode S1, inductor L1, resistors R1 and R2, operational amplifier OA1, logic gates G1 (such as an inverter) and G2 (such as a NAND gate) and transistors Q1 through Q4, which can be implemented as discrete circuit elements, integrated circuit components, a suitable combination of discrete and integrated circuit components or in other suitable embodiments.

The power sources of diagram 400 are voltage input V_{IN} and voltage output V_{OUT}. In this example embodiment, transistor Q1 can provide a function similar to regulator 1 302 and diode D1 as shown in FIG. 3, while transistors Q2 and Q3 can provide a function similar to regulator 2 304 and diode D2. At normal operating condition, when V_{IN} is high enough so that V_{DD} is above 4.5V (or other suitable predetermined voltages), transistor Q4 is in an ON state, which turns off transistors Q2 and Q3. V_{DD} is then supplied by V_{IN} via transistor Q1.

When the voltage at V_{IN} dips so that V_{DD} is lower than 4.5V or V_{IN}+V_{BE}, the circuit enters run-through mode and transistor Q4 turns Off. As a consequence, transistors Q2 and Q3 turn ON. V_{DD} is then supplied from V_{OUT}, to allow the associated circuit (such as a controller) to maintain normal operation, such as to permit the LED drivers to ride through the voltage transient without a flicker, to maintain a voltage to other suitable circuits, or for other suitable purposes. When V_{IN} recovers and reaches a predetermined threshold as determined by the values of R1, R2 and other circuit components, the output of the “run through mode” combination of operational amplifier OA1 and logic switches G1 and G2 is set to LOW. This output turns on transistor Q4 and then shuts off transistors Q2 and Q3, so as to allow the V_{IN} supply to V_{DD} resumes. The ride through process then completes.

FIG. 5 is a diagram 500 of the V_{IN}, V_{OUT}, V_{DD} and LED current (I_{OUT}) waveforms of a circuit controlled by an example device, in accordance with the present disclosure. As can be seen from the waveforms in diagram 500, when V_{IN} drops below 4.3V, the chip voltage source V_{DD} is powered by V_{OUT}. When V_{IN} rises above 4.3V, it powers V_{DD} again. During this process, the supplied current remains almost constant, such as to support LED drivers to prevent blinking of the associated LEDs, transients to other supported circuits, or for other suitable purposes. In this regard, it is noted that while LED applications are disclosed in the pending application, the present disclosure is not limited to such applications and can be used for other suitable applications where voltage supply without large transients is required.

In general, the present disclosure is directed to a circuit that includes a first regulator coupled to a voltage input, wherein the first regulator comprises a transistor and a control input that disables the first regulator when the voltage input is lower than a first predetermined voltage and that enables the first regulator when the voltage input is higher than the first predetermined voltage. A second regulator is coupled to a voltage output, wherein the second regulator comprises a transistor and a control input that enables the second regulator when the voltage input is lower than the first predetermined voltage and that disables the second regulator when the voltage input is higher than the first predetermined voltage. A switch is coupled to the first regulator and the second regulator, wherein the switch is configured to provide voltage to a load from the voltage input when the voltage input is greater than the first predetermined voltage, and to provide voltage to the load from the voltage output when the voltage input is lower than a second predetermined voltage, wherein the first predetermined voltage is equal to the second predetermined voltage, wherein the switch comprises an operational amplifier, a NAND gate, an inverter, a plurality of transistors, a predetermined voltage input and a zener diode.

A method is also disclosed that uses the circuit or other suitable circuits or systems, and that further includes detecting a voltage at an input by comparing the voltage to a reference voltage, or otherwise detecting the voltage at the input. An operational amplifier, a comparator or other suitable devices can be used to perform the comparing step. The method further includes providing current from the input to a circuit if the voltage is greater than a predetermined voltage by providing the current from the input to the circuit through a first diode if the voltage is greater than the predetermined voltage. In addition, the method can include providing current from an output to the circuit if the voltage is less than the predetermined voltage by providing the current from the output to the circuit through a second diode if the voltage is less than the predetermined voltage. A switch can be used to detect the output of the comparing step, where a series of logic gates such as an inverter and NAND gate can be used to control a transistor that activates run-through switches that control whether voltage is selected to be provided to the circuit from the input or from the output, or other suitable switches can also or alternatively be used. In another example embodiment, the method can be implemented as an algorithm in conjunction with a programmable controller or other suitable devices that are implemented in hardware or a suitable combination of hardware and software, such as a field programmable gate array, where the disclosed method steps are algorithmic method steps that are programmed using conventional programming steps.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one example embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth example embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an example order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A circuit comprising:
a first regulator coupled to a voltage input;
a second regulator coupled to a voltage output; and
a switch coupled to the first regulator and the second regulator, wherein the switch is configured to provide voltage to a load from the voltage input when the voltage input is greater than a first predetermined voltage, and to provide voltage to the load from the voltage output when the voltage input is lower than a second predetermined voltage.

2. The circuit of claim 1 wherein the first regulator comprises a control input that disables the first regulator when the voltage input is lower than the first predetermined voltage.

3. The circuit of claim 1 wherein the first predetermined voltage is equal to the second predetermined voltage.

4. The circuit of claim 1 wherein the first regulator comprises a control input that enables the first regulator when the voltage input is higher than the first predetermined voltage.

5. The circuit of claim 1 wherein the second regulator comprises a control input that enables the second regulator when the voltage input is lower than the first predetermined voltage.

6. The circuit of claim 1 wherein the second regulator comprises a control input that disables the second regulator when the voltage input is higher than the first predetermined voltage.

7. The circuit of claim 1 wherein the first regulator comprises a transistor.

8. The circuit of claim 7 wherein the second regulator comprises a transistor.

9. The circuit of claim 1 wherein the switch comprises an operational amplifier.

10. The circuit of claim 1 wherein the switch comprises a NAND gate.

11. The circuit of claim 1 wherein the switch comprises an inverter.

12. The circuit of claim 1 wherein the switch comprises a transistor.

13. The circuit of claim 1 wherein the switch comprises a plurality of transistors.

14. The circuit of claim 1 wherein the switch comprises a predetermined voltage input.

15. The circuit of claim 1 wherein the switch comprises a zener diode.

16. A method for providing a voltage comprising:
detecting a voltage at an input;
providing current from the input to a circuit if the voltage is greater than a predetermined voltage; and
providing current from an output to the circuit if the voltage is less than the predetermined voltage.

17. The method of claim 16 wherein detecting the voltage at the input comprises comparing the voltage to a reference voltage.

18. The method of claim 16 wherein providing the current from the input to the circuit if the voltage is greater than the predetermined voltage comprises providing the current from the input to the circuit through a first diode if the voltage is greater than the predetermined voltage.

19. The method of claim 18 wherein providing the current from the output to the circuit if the voltage is less than the predetermined voltage comprises providing the current from the output to the circuit through a second diode if the voltage is less than the predetermined voltage.

20. In a circuit comprising a first regulator coupled to a voltage input, wherein the first regulator comprises a transistor and a control input that disables the first regulator when the voltage input is lower than a first predetermined voltage and that enables the first regulator when the voltage input is higher than the first predetermined voltage, a second regulator coupled to a voltage output, wherein the second regulator comprises a transistor and a control input that enables the second regulator when the voltage input is lower than the first predetermined voltage and that disables the second regulator when the voltage input is higher than the first predetermined voltage and a switch coupled to the first regulator and the second regulator, wherein the switch is configured to provide voltage to a load from the voltage input when the voltage input is greater than the first predetermined voltage, and to provide voltage to the load from the voltage output when the voltage input is lower than a second predetermined voltage, wherein the first predetermined voltage is equal to the second predetermined voltage, wherein the switch comprises an operational amplifier, a NAND gate, an inverter, a plurality of transistors, a predetermined voltage input and a zener diode, a method comprising:
detecting a voltage at an input by comparing the voltage to a reference voltage;
providing current from the input to a circuit if the voltage is greater than a predetermined voltage by providing the current from the input to the circuit through a first diode if the voltage is greater than the predetermined voltage; and
providing current from an output to the circuit if the voltage is less than the predetermined voltage by providing the current from the output to the circuit through a second diode if the voltage is less than the predetermined voltage.
